(19) United States
(12) Patent Application Publication
(10) Pub. No.: US 2026/0282178 A1
(43) Pub. Date: Sep. 17, 2026

(54) COOKING APPLIANCE

(71) Applicants: Guangdong Galanz Enterprises Co., Ltd., Foshan City (CN); Guangdong Galanz Appliances Manufacturing Co., Ltd., Zhongshan City (CN); Guangdong Galanz Microwave Oven and Electrical Appliances Manufacturing Co., Ltd., Foshan City (CN)

(72) Inventors: HaoSheng YANG, Foshan City (CN); Feng LI, Foshan City (CN); Qian LIU, Foshan City (CN); WeiChang FENG, Foshan City (CN); ChaoHua CUI, Foshan City (CN)

(21) Appl. No.: 19/569,052

(22) Filed: Mar. 17, 2026

(30) Foreign Application Priority Data
Mar. 17, 2025 (CN) 202520458209.6
Mar. 28, 2025 (CN) 202520570030.X
Mar. 31, 2025 (CN) 202520587389.8
Apr. 15, 2025 (CN) 202520703467.6

(51) Int. Cl. H05B 6/64

(52) U.S. Cl. CPC H05B 6/6426

(57) ABSTRACT

The present invention provides a cooking appliance, comprising a housing, wherein a heating chamber is disposed within the housing, a support structure is disposed on a side wall of the heating chamber for supporting a partition component, and a limiting protrusion structure is disposed on the side wall for limiting the partition component when it is pulled out; the housing comprises a base, the base is located at a lower portion of the heating chamber, a pullable storage member is disposed below the base, and a gap exists between the storage member and the base. The present invention improves space utilization by forming an accommodating space at the bottom of the cooking appliance, while the arrangement of the limiting protrusion structure can limit the partition component when the partition component is pulled out to prevent tipping.

### CROSS-REFERENCE TO RELATED APPLICATIONS

This application claims priority to Chinese Patent Application No. 202520458209.6 filed with the China National Intellectual Property Administration (CNIPA) on Mar. 17, 2025, and Chinese Patent Application No. 202520570030.X filed with CNIPA on Mar. 28, 2025, and Chinese Patent Application No. 202520587389.8 filed with CNIPA on Mar. 31, 2025, and Chinese Patent Application No. 202520703467.6 filed with CNIPA on Apr. 15, 2025, the disclosures of all of which are incorporated herein by reference in their entireties.

### TECHNICAL FIELD

The present invention relates to the technical field of home appliances, and more specifically, to a cooking appliance.

### BACKGROUND

With the continuously increasing performance requirements of modern households for kitchen appliances, cooking appliance incorporating dual magnetrons has emerged and has gradually become representative of high-end cooking appliance products. Although such cooking appliance has high cavity heating efficiency, the space utilization of the cavity is low when processing small amounts of food at one time; a partition component can divide it into two relatively independent spaces to meet usage requirements for different scenarios, but it is prone to tipping over when pulled out; such cooking appliance is heavy, and its bottom structure typically only considers support strength, resulting in low space utilization, while conventional handle structures also make it difficult for assisting personnel to apply force, leading to transportation difficulties. In addition, the power cord of the cooking appliance is directly routed out from a through-hole at the rear, which during use can cause pulling on internal components and affect performance reliability.

### SUMMARY OF THE INVENTION

To solve the above problems, the present invention provides a cooking appliance, comprising a housing, wherein the housing is provided with a third protective member for protecting the power cord; a heating chamber is provided in the housing, a support structure is provided on a side wall of the heating chamber for supporting a partition component, a limiting protrusion structure is provided on the side wall for limiting the partition component when the partition component is pulled out; the housing comprises a base, the base is located at a lower portion of the heating chamber, a pullable storage member is provided below the base, and a gap exists between the storage member and the base.

Preferably, the cooking appliance comprises a first protective member and a second protective member, the first protective member and the second protective member are respectively located on both sides of the base and cooperate with each other to form a slide track, and the storage member is slidably assembled to the slide track.

Preferably, the first protective member and/or the second protective member is connected to the base through screw connection and/or snap connection, or the first protective member and/or the second protective member is integrally formed with the base.

Preferably, the cooking appliance comprises a water tank, snap buckles are respectively provided on both sides of the water tank, snap columns are provided on a side of the first protective member and the second protective member close to the water tank, and the snap buckles can be snap-fitted to the snap columns.

Preferably, a second handle portion is provided on a front side of the storage member, a bottom portion of the water tank is recessed upward to form a clearance zone for accommodating the second handle portion, and the snap buckles are located on both sides of the clearance zone.

Preferably, the first protective member and the second protective member are symmetrically provided on both sides of the base, and the first protective member is provided with a first handle portion.

Preferably, the power cord includes a first end and a second end extending along a first direction and a second direction respectively, wherein both the first end and the second end are located within the third protective member, and the third protective member is detachably connected to the housing.

Preferably, the first direction and the second direction are arranged perpendicular to each other, and the third protective member and the housing are assembled through plug-in connection and screw connection.

Preferably, the housing includes a rear panel, wherein a portion of the rear panel protrudes rearward to form a first mounting platform, and a portion of the first mounting platform protrudes rearward to form a second mounting platform, and the third protective member is assembled in a limited position to the first mounting platform.

Preferably, the housing is provided with a third protective member for protecting a power cord; the third protective member includes a main body, wherein one end of the main body is provided with a limiter, one side of the main body is provided with a plug-in block, the second end of the power cord is led out from the plug-in block, and the first end of the power cord is led out from the limiter, wherein an insertion hole is provided on the first mounting platform, and the plug-in block is assembled in a limited position within the insertion hole.

Preferably, an open slot is provided between the main body and the plug-in block, the open slot is located at the end of the main body proximate to the limiter, and the bottom of the open slot abuts against the upper edge of the insertion hole.

Preferably, the partition component is disposed above the support structure, a limiting protrusion structure is provided on the side wall, the limiting protrusion structure is disposed above the partition component, and the limiting protrusion structure is disposed on a side proximate to the opening.

Preferably, grooves are provided on the left and right sides of the partition component, the grooves are disposed on a side distal from the opening, and the grooves cooperate with the limiting protrusion structure.

Preferably, the support structure includes a first support protrusion, the limiting protrusion structure includes a first limiting protrusion, the first limiting protrusion is obliquely disposed above the first support protrusion, and the first limiting protrusion is obliquely disposed in a direction approaching the opening with an inclination angle α of 10° to 80°.

Preferably, the limiting protrusion structure further includes a second limiting protrusion, and the second limiting protrusion is disposed on the first support protrusion.

Preferably, the housing includes a rear panel, the rear panel is provided with a detachable handle member, and a handle space is formed between the handle member and the rear panel.

Preferably, the cooking appliance includes an anti-collision member, and the anti-collision member is connected to a protrusion portion of the rear panel in a detachable manner.

Preferably, the cooking appliance includes a first magnetron and a second magnetron disposed on the base.

Compared with the prior art, the cooking appliance of the present invention has the following beneficial effects: 1) An accommodation space for storing paper menus is formed at the bottom of the cooking appliance, avoiding the problem that menus or instruction manuals are easily lost when placed randomly, which is particularly suitable for scenarios requiring frequent reference to recipes; 2) The provision of the limiting protrusion structure can limit the partition component when the partition component is pulled out, preventing the partition component from tipping over; the combination of the support structure and the limiting protrusion structure ensures the stability and safety of the partition component during the pulling-out process; 3) The provided handle member facilitates two or more persons to conveniently and collaboratively carry large-volume and heavy-weight cooking appliance.

### BRIEF DESCRIPTION OF THE DRAWINGS

FIG. 1 is a schematic diagram of the overall structure of the cooking appliance according to an embodiment of the present invention;

FIG. 2 is an exploded schematic diagram of the cooking appliance according to an embodiment of the present invention;

FIG. 3 is a schematic diagram of the structure of the base according to an embodiment of the present invention;

FIG. 4 is a schematic diagram of the structure of the first protective member according to an embodiment of the present invention;

FIG. 5 is a view from another angle of the first protective member according to an embodiment of the present invention;

FIG. 6 is a schematic diagram of the structure of the storage member according to an embodiment of the present invention;

FIG. 7 is a rear perspective view of the cooking appliance according to an embodiment of the present invention;

FIG. 8 is an exploded view of the cooking appliance according to an embodiment of the present invention;

FIG. 9 is a schematic diagram of the structure of the handle member according to an embodiment of the present invention;

FIG. 10 is a schematic structural view of the rear panel according to an embodiment of the present invention;

FIG. 11 is an assembly schematic view of the third protective member and the power cord according to an embodiment of the present invention;

FIG. 12 is another perspective view of the assembly of the third protective member and the power cord according to an embodiment of the present invention;

FIG. 13 is a schematic structural view of the cooking appliance (without the door assembly) according to an embodiment of the present invention;

FIG. 14 is an enlarged perspective structural view of portion A in FIG. 13;

FIG. 15 is another perspective view of the cooking appliance (without the door assembly) according to an embodiment of the present invention;

FIG. 16 is an enlarged perspective structural view of portion B in FIG. 15;

FIG. 17 is yet another perspective view of the cooking appliance (without the door assembly) according to an embodiment of the present invention;

FIG. 18 is still another perspective view of the cooking appliance (without the door assembly) according to an embodiment of the present invention.

### DESCRIPTION OF REFERENCE NUMERALS

100—housing; 10—base; 101—first boss; 102—second boss; 103—first air inlet; 104—clearance portion; 105—protrusion; 106—positioning hole; 107—fixing hole; 108—second air inlet; 20—rear panel; 2001—first mounting platform; 2002—second mounting platform; 2003—insertion hole; 2004—first mounting hole; 2005—snap hole; 2006—second mounting hole; 2007—first assembly hole; 2008—protrusion portion; 2009—anti-collision member; 30—first protective member; 31—first guard plate; 311—first handle portion; 312—positioning post; 32—second guard plate; 321—first ventilation hole; 322—first foot; 323—abutting block; 324—third mounting hole; 325—snap column; 326—second foot; 327—sliding groove; 328—protrusion block; 40—storage member; 41—second ventilation hole; 42—second handle portion; 43—first snap portion; 44—second snap portion; 45—receiving portion; 50—water tank; 51—clearance zone; 52—snap buckle; 60—second protective member; 70—paper menu; 80—third protective member; 81—main body; 811—recessed portion; 812—first inclined surface; 813—second assembly hole; 82—plug-in block; 83—limiter; 831—spacing groove; 84—open slot; 90—handle member; 91—mounting portion; 92—fourth mounting hole; 93—claw; 94—upper enclosure plate; 95—finger abutment plate; 96—rib plate; 97—reinforcing plate; 98—side enclosure plate; 99—rear enclosure plate;
200—heating chamber; 201—side wall; 202—rear wall; 203—opening; 21—partition component; 211—groove; 22—limiting protrusion structure; 221—first limiting protrusion; 222—second limiting protrusion; 223—third limiting protrusion; 23—guiding reinforcement structure; 231—first guiding reinforcing rib; 232—second guiding reinforcing rib; 2301—guiding reinforcing rib main body; 2302—guiding reinforcing edge; 24—support structure; 241—first support protrusion; 242—second support protrusion; 243—third support protrusion; 25—protective protrusion; 26—sensor;
300—door assembly;
400—power cord; 401—first end; 402—second end.

### DETAILED DESCRIPTION OF THE EMBODIMENTS

To make the above-mentioned objects, features, and advantages of the present invention more apparent and understandable, detailed descriptions of specific embodiments of the present invention are provided below in conjunction with the accompanying drawings. Without conflict, the technical features of the embodiments of the present invention may be combined with each other.

In the description of the present invention, unless otherwise explicitly specified and limited, the terms “mounted,” “connected,” and “coupled” should be understood in a broad sense. For example, they may refer to a fixed connection, a detachable connection, or an integral connection; they may refer to a mechanical connection; they may refer to a direct connection or an indirect connection through an intermediate medium; or they may refer to internal communication between two elements. For those of ordinary skill in the art, the specific meanings of the above terms in the present invention may be understood according to specific circumstances.

In the description of this specification, descriptions with reference to the terms “one embodiment,” “some embodiments,” “illustrative embodiment,” “examples,” “specific examples,” or “some examples” mean that specific features, structures, materials, or characteristics described in conjunction with the embodiment or example are included in at least one embodiment or example of the present invention. In this specification, the schematic representations of the above terms do not necessarily refer to the same embodiment or example. Furthermore, the specific features, structures, materials, or characteristics described may be combined in any suitable manner in any one or more embodiments or examples.

Typically, a microwave oven comes with a paper menu 70 containing instructions at the time of shipment, which requires users to store it themselves. For users, this not only requires additional space, but also causes the menu to be separated from the microwave oven, greatly reducing the accessibility of the menu during use and resulting in a poor user experience. To address this, the applicant proposes the following technical solution:

### Embodiment 1

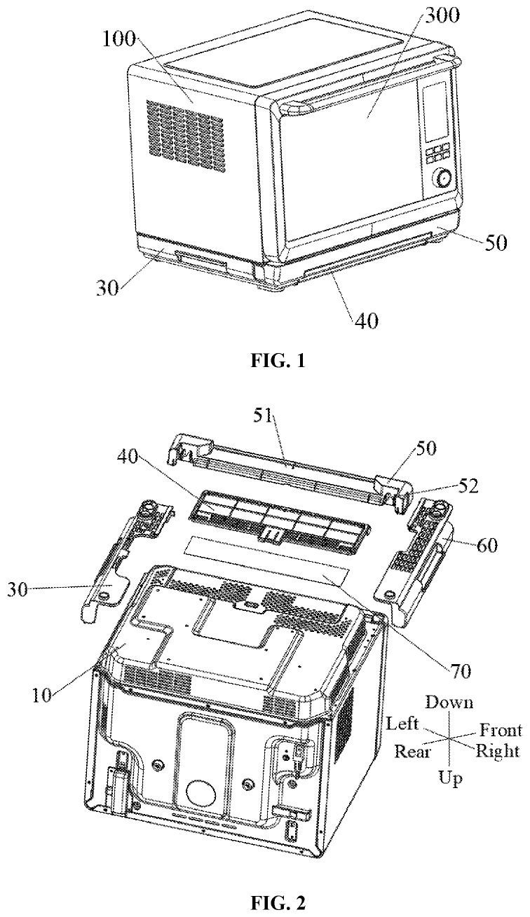

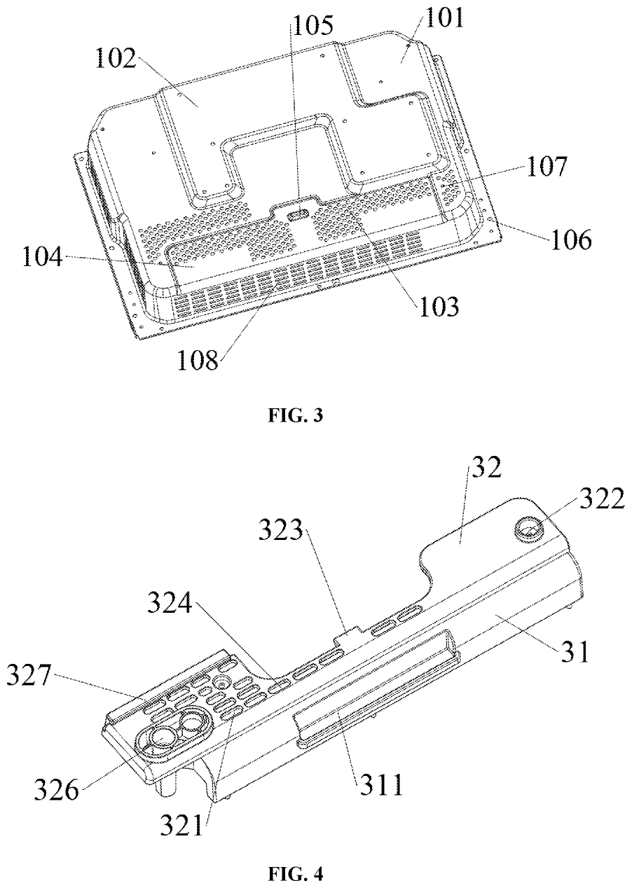

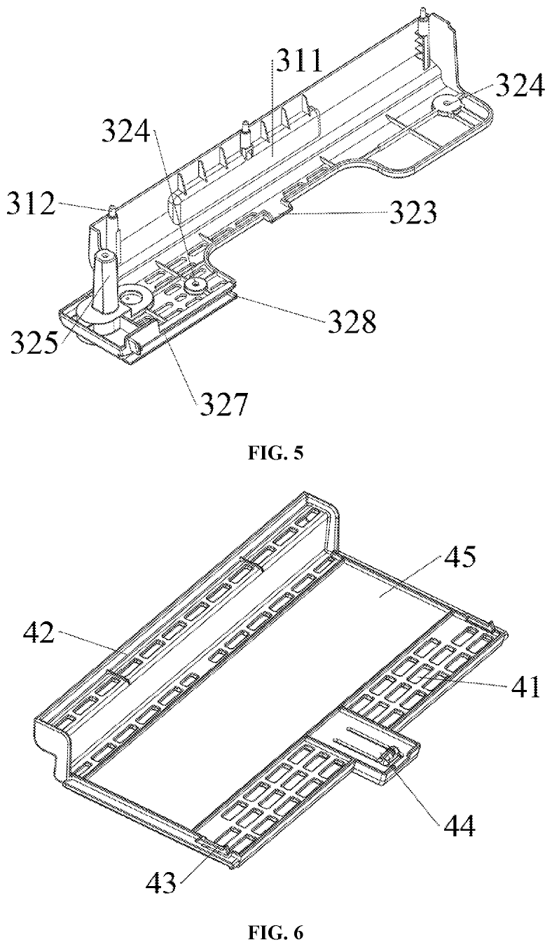

As shown in FIGS. 1-6, a cooking appliance includes a base 10, wherein a first protective member 30 and a second protective member 60 are respectively disposed on two sides of the base 10, and the first protective member 30 and the second protective member 60 cooperate with each other to form a slide track for assembling a slidable storage member 40, wherein a gap exists between the storage member 40 and the base 10 for placing a paper menu 70.

This arrangement utilizes the redundant gap between the base 10 and the storage member 40 to achieve storage of the paper menu 70, avoiding the loss or creasing problems caused by random placement of the paper menu 70 in traditional methods, and is particularly suitable for scenarios requiring frequent reference to recipes (such as microwave ovens and ovens); no additional increase in equipment volume or external accessories is required, maintaining the simple appearance of the cooking appliance. The base 10 is a part of the housing 100 of the cooking appliance, and the remaining parts of the housing 100 are prior art and will not be described in detail herein.

As a preferred example, a portion of the base 10 protrudes downward to form a first boss 101, and a portion of the first boss 101 protrudes downward to form a second boss 102. The first protective member 30 and the second protective member 60 are respectively fixedly disposed on two sides of the first boss 101, and are flush with the second boss 102 after assembly. This arrangement can utilize the assembly space provided for the first protective member 30 and the second protective member 60, so that after assembly, the first protective member 30 and the second protective member 60 do not protrude from the base 10, resulting in an aesthetically pleasing overall appearance.

As a preferred example, a first air inlet 103 and a second air inlet 108 are respectively disposed on the bottom and the side of the first boss 101. The first protective member 30 includes a first guard plate 31 and a second guard plate 32 that are connected to each other, and the first guard plate 31 and the second guard plate 32 respectively abut against the bottom and the side of the first boss 101.

This arrangement utilizes the first protective member 30 to simultaneously protect the bottom and the side of the base 10, while concealing the air inlets to maintain the simple appearance of the cooking appliance; it can also effectively prevent the air inlets of the base 10 from being blocked by foreign objects, which is beneficial for heat dissipation of the electrical components at the bottom; through the first air inlet 103 and the second air inlet 108, a three-dimensional air intake channel is formed to accelerate air flow into the interior of the base 10 from different directions, and in combination with the exhaust system of the cooking appliance, the heat from core components such as the magnetron and circuit board can be quickly removed, avoiding high temperatures from affecting the preservation of the paper menu 70 or the lifespan of electronic components.

As a preferred example, the base 10 is provided with a positioning hole 106, the first protective member 30 is provided with a positioning post 312, and the positioning post 312 is inserted and assembled into the positioning hole 106; the base 10 is further provided with a fixing hole 107, the first protective member 30 is provided with a third mounting hole 324 at a position corresponding to the fixing hole 107, and the fixing hole 107 and the third mounting hole 324 are connected by screws.

As a preferred example, the bottom portion of the second guard plate 32 protrudes to form a first foot 322 and a second foot 326, and the first foot 322 and the second foot 326 are spaced apart from each other and disposed higher than the second boss 102. This arrangement can form support for the cooking appliance as a whole, while a gap exists below the base 10, which is conducive to conveying air into the base 10 for heat dissipation; at the same time, it can raise the gap between the bottom of the base 10 and the countertop, preventing water accumulation or oil stains on the countertop from directly contacting the second boss 102, while reducing dust accumulation below the air inlet; the first foot 322 and the second foot 326 are integrally formed with the second guard plate 32 by stamping or injection molding, reducing welding/bonding processes, lowering manufacturing costs, and ensuring structural stability.

Preferably, the second guard plate 32 is provided with a plurality of first ventilation holes 321. This arrangement can reduce the weight of the second guard plate 32, while also facilitating entry of external air into the base 10, effectively reducing the impact of the first protective member 30 on heat dissipation of components within the base 10.

As a preferred example, the first guard plate 31 is partially recessed upward to form a first handle portion 311, facilitating carrying. As a preferred example, the second guard plate 32 is provided with an abutting block 323 on a side adjacent to the second boss 102, and the abutting block 323 abuts against the second boss 102. This arrangement can provide positioning limitation for the assembly of the first protective member 30, while the force on the first protective member 30 is transmitted to the base 10, resulting in a long service life.

Preferably, the second guard plate 32 is provided with a sliding groove 327 on a side away from the first guard plate 31, and the rear end of the sliding groove 327 is provided with a protrusion block 328; a side portion of the storage member 40 is provided with a first snap portion 43, and the first snap portion 43 is snap-connected and assembled with the protrusion block 328.

When the storage member 40 slides a certain distance along the sliding groove 327, the snap connection between the protrusion block 328 and the first snap portion 43 provides clear tactile feedback (such as a “click” sound); this effectively prevents accidental sliding out caused by vibration of the cooking appliance or inadvertent contact, ensuring stable storage of the paper menu 70 during the cooking process; the sliding groove 327 and the protrusion block 328 are integrated on the side edge of the second guard plate 32, without additionally occupying internal space of the equipment, ensuring maximization of the capacity of the storage member 40. As a preferred example, the first snap portion 43 is formed by bending a side portion of the storage member 40 toward one side. The installation method of the second protective member 60 is the same as that of the first protective member 30, and its structure can be the same as the first protective member 30, or can be adjusted according to the specific shape of the base 10, which will not be elaborated here.

As a preferred example, the first boss 101 is partially recessed upward to form a clearance portion 104, the clearance portion 104 is provided with a protrusion 105, a second snap portion 44 is provided on the upper part of the storage member 40 at a position corresponding to the protrusion 105, and the second snap portion 44 is assembled in snap connection with the protrusion 105.

This arrangement cooperates with the first snap portion 43 to form multi-point engagement, improving the fastening reliability and convenience of assembly of the storage member 40.

As a preferred example, the storage member 40 forms a second handle portion 42 on a side away from the second snap portion 44, and a portion of the storage member 40 on the side close to the base 10 is recessed downward to form a receiving portion 45 for placing a paper menu 70. This arrangement facilitates the user to pull the storage member 40 out from the lower part of the base 10. The storage member 40 is provided with second ventilation holes 41, and the second ventilation holes 41 are located on the front and rear sides of the receiving portion 45. This arrangement can serve the purpose of weight reduction and save raw materials; meanwhile, it can enable air to enter the base 10 more smoothly, which is beneficial for heat dissipation of components.

As a preferred example, the cooking appliance further includes a water tank 50, and the water tank 50 is partially recessed upward to form a clearance zone 51 for avoiding the second handle portion 42; the second guard plate 32 is provided with a snap column 325 on a side away from the first foot 322, the water tank 50 is provided with a snap buckle 52, and the snap buckle 52 can be assembled in snap connection to the snap column 325. This arrangement enables the storage member 40 and the water tank 50 to not interfere with each other, facilitating user operation; meanwhile, the water tank 50 can collect condensate generated by pre-cooling of the door assembly 300, preventing it from flowing freely, resulting in good user experience. Preferably, the snap column 325 and the second foot 326 are arranged coaxially. This arrangement can improve the strength of the second foot 326 while facilitating mold release operation.

During assembly, the first protective member 30 and the second protective member 60 are first inserted into the positioning holes 106 via the positioning posts 312, then the third mounting holes 324 and the fixing holes 107 are connected by screws; thereafter, the water tank 50 is assembled in a limiting manner with the snap columns 325 of the first protective member 30 and the second protective member 60 respectively via the snap buckles 52 on both sides; finally, the two sides of the storage member 40 with the paper menu 70 placed thereon are slid forward along the sliding grooves 327 of the first protective member 30 and the second protective member 60 respectively, and are assembled in a limiting manner with the first protective member 30 and the second protective member 60 respectively via the first snap portions 43 on both sides, while the second snap portion 44 is assembled in a limiting manner with the base 10; the second handle portion 42 of the storage member 40 is received in the clearance zone 51 of the water tank 50, forming support for the water tank 50; the assembly sequence of the storage member 40 and the water tank 50 can also be adjusted.

### Embodiment 2

For certain cooking appliance, such as microwave ovens having two magnetrons, the heavy weight makes them inconvenient to carry. To address this, the applicant proposes the following solution based on Embodiment 1:

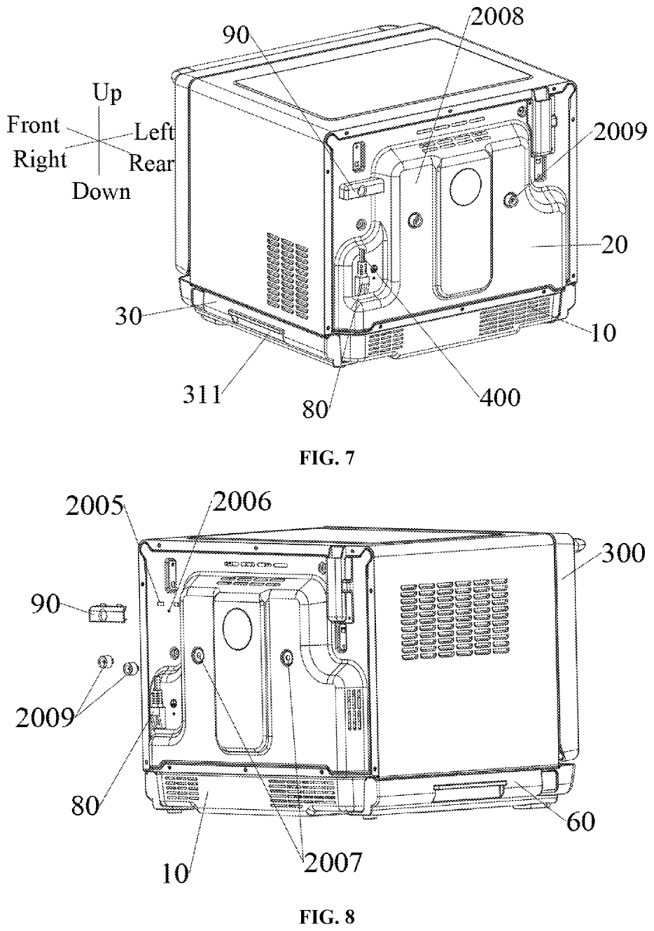

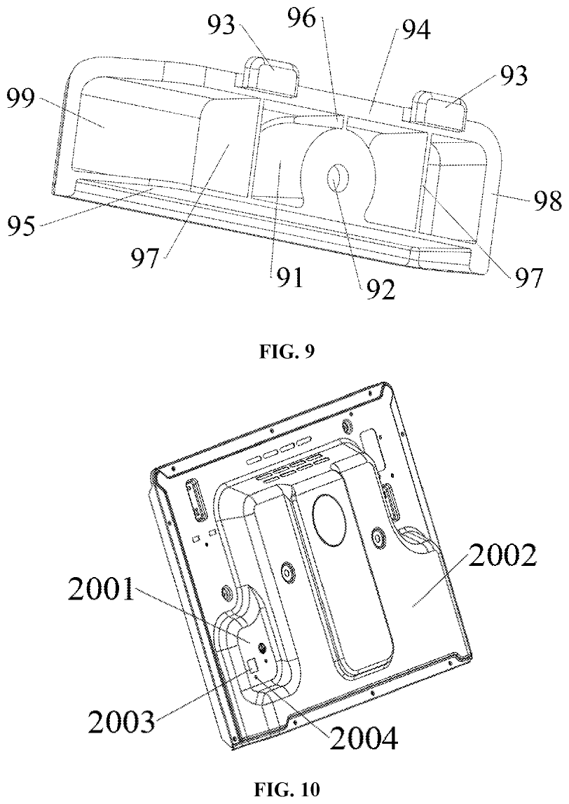

As shown in FIGS. 7-9, a cooking appliance includes a rear panel 20 and a handle member 90. The handle member 90 is detachably connected to the rear panel 20, and a handle space is formed between the handle member 90 and the rear panel 20, providing the user with an additional safe gripping position.

In consideration of carrying large-volume and heavy-weight cooking appliance, the present application provides a detachable handle member 90 at the rear panel 20. If the user can carry alone, the handle member 90 may be removed to reduce the overall space occupied by the cooking appliance. If not, since the handle member 90 located at the rear panel 20 is not in the same orientation as the first handle portion 311 of the conventional first protective member 30 and second protective member 60, assisting personnel can safely and conveniently provide assistance through the handle member 90 without spatial interference with another person, enabling two or more persons to conveniently perform coordinated carrying of large-volume and heavy-weight cooking appliance.

Additionally, a door assembly 300 is typically provided at the front side of the cooking appliance, and the door assembly 300 often has a handle. The user may also stand on the left or right side of the cooking appliance and carry it using the handle member 90 and the handle of the door assembly 300, thereby avoiding the use of the first handle portion 311 of the conventional first protective member 30 and second protective member 60. This prevents unnecessary collision between the user and the door assembly 300 during carrying, reducing the probability of the door glass being broken.

The handle member 90 includes at least an upper enclosure plate 94 and a rear enclosure plate 99. The rear end of the upper enclosure plate 94 is connected to the upper end of the rear enclosure plate 99. A handle space is formed among the upper enclosure plate 94, the rear enclosure plate 99, and the rear panel 20, allowing fingers to be inserted into the handle space to facilitate gripping.

Regarding the connection between the handle member 90 and the rear panel 20, the handle member 90 is provided with a mounting portion 91. The mounting portion 91 extends toward the rear panel 20, and a fourth mounting hole 92 is provided on a side of the mounting portion 91 proximate to the rear panel 20. The rear panel 20 is provided with a second mounting hole 2006. The fourth mounting hole 92 and the second mounting hole 2006 are connected by a fastener to ensure reliable assembly while also facilitating disassembly and assembly. Preferably, the mounting portion 91 is provided on the rear enclosure plate 99. Since the rear enclosure plate 99 is approximately parallel to the rear panel 20, the mounting portion 91 can extend horizontally toward the rear panel 20, facilitating the assembly of the fastener.

For ease of installation, the handle member 90 is provided with a claw 93, and the rear panel 20 is provided with a snap hole 2005. The claw 93 can form a snap connection with the snap hole 2005, which on one hand helps improve assembly reliability, and on the other hand, the snap connection positioning between the claw 93 and the snap hole 2005 provides positioning pre-assembly for the handle member 90 and the rear panel 20. Upon completion of the pre-assembly, the fourth mounting hole 92 and the second mounting hole 2006 can automatically align, facilitating direct installation of fasteners and helping improve assembly efficiency. Preferably, the claw 93 is provided on a side of the upper enclosure plate 94 close to the rear panel 20.

The handle member 90 includes a finger abutment plate 95. The finger abutment plate 95 is connected to a side surface of the rear enclosure plate 99 close to the rear panel 20, and a lower surface of the finger abutment plate 95 is higher than a lower edge of the rear enclosure plate 99, so that when a user applies force to the handle member 90, fingers extending into the handle space can abut against the lower surface of the finger abutment plate 95, increasing the contact area at the fingers and facilitating user force application. Meanwhile, due to the blocking effect of the finger abutment plate 95, it prevents the user's fingers from extending too far into the handle space, avoiding discomfort to the user's fingers caused by contact between the lower edge of the rear enclosure plate 99 and the user's fingers.

Since the rear enclosure plate 99 is also provided with the mounting portion 91, preferably, in the vertical direction, the mounting portion 91 is arranged between the upper enclosure plate 94 and the finger abutment plate 95. One side of the mounting portion 91 is connected to the finger abutment plate 95, and the other side of the mounting portion 91 is provided with a rib plate 96. The rib plate 96 extends toward the upper enclosure plate 94 and is connected to the upper enclosure plate 94, so that on the basis of all being connected to the rear enclosure plate 99, the upper enclosure plate 94, the mounting portion 91, and the finger abutment plate 95 are also connected in sequence, which helps optimize the force distribution of the entire handle member 90, prevents structural damage caused by localized stress concentration, and also helps improve the mechanical strength of the entire handle member 90.

Further, a reinforcing plate 97 is provided between the upper enclosure plate 94 and the finger abutment plate 95. An upper end of the reinforcing plate 97 is connected to the upper enclosure plate 94, a lower end of the reinforcing plate 97 is connected to the finger abutment plate 95, and a rear end of the reinforcing plate 97 is connected to the rear enclosure plate 99, so that inside the entire handle member 90, internal reinforcement and support are provided by arranging the reinforcing plate 97, to further improve the mechanical strength of the handle member 90.

A side enclosure plate 98 is provided on a left side and/or a right side of the handle member 90. The side enclosure plate 98 is integrally connected with the upper enclosure plate 94 and the rear enclosure plate 99, so that after fingers extend into the handle space, they can be constrained in the left-right direction, preventing carrying accidents caused by fingers sliding laterally out of the handle space during carrying.

For rear panels 20 of conventional cooking appliance, there is often a protrusion portion 2008. Correspondingly, the present application preferably utilizes the protrusion portion 2008 to constrain fingers on the left or right side. Specifically, one side of the handle member 90 abuts against the protrusion portion 2008, and the other side is provided with a side enclosure plate 98, so that after fingers extend into the handle space, the fingers can be jointly constrained by the protrusion portion 2008 on one side and the side enclosure plate 98 on the other side. While retaining and utilizing the conventional rear panel 20 structure, this also simplifies the structure of the handle member 90 itself. Of course, if the rear panel 20 is configured as a flat plate without a protrusion portion 2008, side enclosure plates 98 can be provided on both left and right sides of the handle member 90.

Additionally, the entire handle member 90 in the present application is preferably integrally formed, such as by injection molding, which on one hand facilitates actual production and processing, and on the other hand can effectively ensure that the handle member 90 has good mechanical strength.

For a conventional rear panel 20 provided with a protrusion portion 2008, which is an outwardly protruding structure, it is often used to provide spatial clearance for certain components inside the cooking appliance. After the cooking appliance has been transported and placed, when adjusting its position, improper movement often causes the protrusion portion 2008 to collide with a wall. In order to prevent direct collision between the protrusion portion 2008 and the wall, the cooking appliance includes an anti-collision member 2009, and the anti-collision member 2009 is connected to the protrusion portion 2008 of the rear panel 20 in a detachable manner.

Preferably, the anti-collision member 2009 has a certain degree of elasticity, so that even if collision with a wall occurs when moving the cooking appliance, it can provide a certain amount of cushioning to prevent excessive impact force from being transmitted to the rear panel 20.

The protrusion portion 2008 is provided with a first assembly hole 2007, and the anti-collision member 2009 is provided with an assembly end at the end proximate to the protrusion portion 2008. The assembly end is connected to the first assembly hole 2007 by at least any one of snap connection, fastener connection, or pin connection, so as to ensure convenience in the assembly and disassembly of the anti-collision member 2009.

### Embodiment 3

For built-in cooking appliance, the power cord 400 drawn out from the rear panel 20 of the housing 100 along the same direction is typically passively bent 90 degrees to allow the microwave oven to be positioned as close as possible to the rear side wall of the installation cavity. This exerts force on the power cord 400 outlet structure and may even reduce its assembly reliability, while also affecting the service life of the power cord 400 itself. To address this, the applicant proposes the following technical solution:

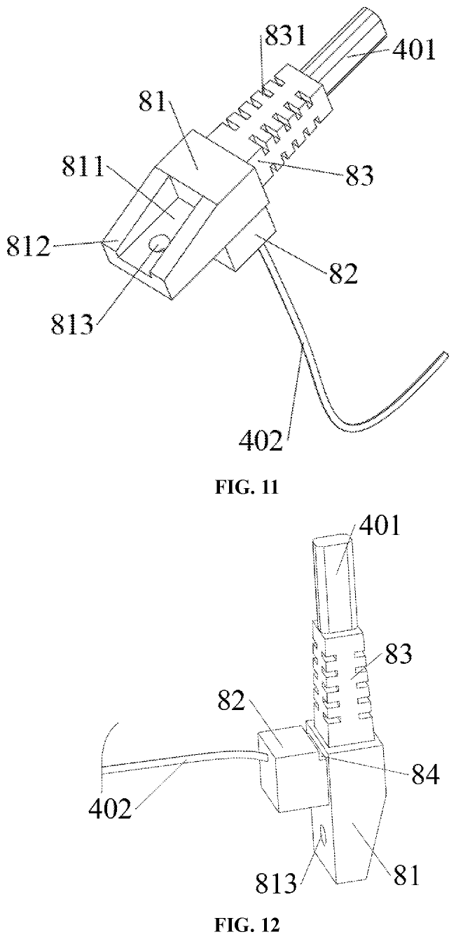

As shown in FIGS. 7-8 and FIGS. 10-12, a cooking appliance includes a housing 100, wherein the housing 100 is provided with a third protective member 80 for protecting the power cord 400. The power cord 400 includes a first end 401 and a second end 402 extending along a first direction and a second direction, respectively. Both the first end 401 and the second end 402 are located within the third protective member 80. The third protective member 80 is detachably connected to the housing 100.

In the present application, the third protective member 80 simultaneously performs the functions of securing, bend resistance, and pull protection for the power cord 400, without requiring additional independent components such as cover plates and screws, thereby significantly reducing the number of parts and lowering manufacturing costs. Meanwhile, the direct detachable connection between the third protective member 80 and the housing 100 simplifies the assembly process, improves production efficiency, and facilitates subsequent maintenance or replacement of the power cord 400. Furthermore, the third protective member 80 achieves a dual-end vertical layout for the power cord 400, meaning that the first end 401 (external outlet end) and the second end 402 (internal connection end) of the power cord 400 are vertically distributed within the third protective member 80, avoiding the stress concentration problem caused by single-point bending in traditional straight-through configurations, and effectively preventing the power cord 400 from breaking due to frequent bending. This is particularly suitable for built-in microwave ovens, where the first end 401 of the power cord 400 can be routed smoothly along the surface of the housing 100, avoiding cable damage caused by excessive bending or compression during installation.

As a preferred example, the third protective member 80 is assembled with the housing 100 through plug-in connection and screw connection. This configuration enables pre-location of the third protective member 80 relative to the housing 100 through the plug-in structure, without requiring precise alignment with threaded holes, simplifying assembly steps, and is particularly suitable for automated production lines, improving assembly efficiency. On this basis, screws are used to reinforce key stress points, avoiding the risk of vibration-induced loosening that may exist with plug-in connection alone.

As a preferred example, the housing 100 includes a rear panel 20, wherein part of the rear panel 20 protrudes rearward to form a first mounting platform 2001, and part of the first mounting platform 2001 protrudes rearward to form a second mounting platform 2002. The third protective member 80 is assembled in a limited position to the first mounting platform 2001.

This configuration causes the first mounting platform 2001 and the second mounting platform 2002 to protrude in stages, forming a stepped space that physically isolates the routing path of the power cord 400 outside the housing 100 from other internal components of the microwave oven, preventing the cable from contacting high-temperature or moving parts while optimizing internal space utilization. Limiting the third protective member 80 to the first mounting platform 2001 does not increase the thickness of the microwave oven, which is beneficial for achieving a compact layout.

As a preferred example, the third protective member 80 includes a main body 81, one end of the main body 81 is provided with a limiter 83, one side of the main body 81 is provided with a plug-in block 82, the second end 402 of the power cord 400 extends from the plug-in block 82, the first end 401 of the power cord 400 extends from the limiter 83, the first mounting platform 2001 is provided with an insertion hole 2003, and the plug-in block 82 is limitingly assembled into the insertion hole 2003.

This arrangement enables blind-plug installation without the need for manual fine adjustment, improving assembly efficiency and being particularly suitable for automated production lines; the second end 402 of the power cord 400 extends from inside the plug-in block 82, and the rigid structure of the plug-in block 82 provides bending protection for the cable root, avoiding fatigue fracture caused by repeated bending when the cable hangs freely at a conventional opening; the plug-in block 82 is embedded in the insertion hole 2003 of the first mounting platform 2001, preventing externally protruding cables from affecting the compactness of wall-mounted microwave oven installation.

The cross-sectional shape of the plug-in block 82 matches the shape of the insertion hole 2003, such as square, rectangular, or circular. Preferably, the limiter 83 is provided with a plurality of spacing grooves 831 along the extension direction of the power cord 400. This arrangement divides the extension path of the power cord 400 into multiple independently fixed regions, avoiding stress concentration from single-point bending and reducing the risk of cable fatigue fracture caused by repeated bending; meanwhile, the raised portions between the spacing grooves 831 form elastic clamping on the power cord 400, allowing the cable to undergo slight displacement during thermal expansion and contraction or vibration while maintaining overall fixation.

Preferably, the main body 81 has a first inclined surface 812 on the side away from the limiter 83, the first inclined surface 812 partially recesses toward the plug-in block 82 side to form a recessed portion 811, a second assembly hole 813 is provided on the recessed portion 811, a first mounting hole 2004 is provided on the first mounting platform 2001, and the first mounting hole 2004 and the second assembly hole 813 are connected by screws.

This arrangement achieves rigid locking between the second assembly hole 813 and the first mounting hole 2004 through screws, and together with the limiting assembly of the plug-in block 82, forms a dual “plug-in+screw connection” fixation, significantly improving vibration resistance and pull resistance; the design of the recessed portion 811 allows the screws to be recessed below the surface of the third protective member 80, preventing loosening or falling off of the screws due to external impact, and does not affect wall-mounted microwave oven installation or coordination with cabinets, making the overall structure more aesthetically pleasing.

Preferably, an open slot 84 is provided between the main body 81 and the plug-in block 82, the open slot 84 is located at the end of the main body 81 close to the limiter 83, and the bottom of the open slot 84 abuts against the upper edge of the insertion hole 2003. This arrangement utilizes the abutment between the bottom wall of the open slot 84 and the upper edge of the insertion hole 2003 to limit the upper portion of the third protective member 80 in both left-right and front-rear dimensions, while cooperating with the second assembly hole 813 and the first mounting hole 2004 to limit the lower portion of the third protective member 80, ensuring precise alignment between the power cord 400 outlet end and the preset position of the housing 100.

During assembly, the plug-in block 82 of the third protective member 80 is inserted into the insertion hole 2003, then the third protective member 80 is pushed upward along the outer wall of the housing 100 so that the insertion hole 2003 is limitingly assembled into the open slot 84, at which point the upper edge of the insertion hole 2003 abuts against the bottom of the open slot 84, thereby preventing the third protective member 80 from wobbling left-right and/or front-rear, while the second assembly hole 813 aligns with the first mounting hole 2004, and the two are fixedly connected by screws; through the third protective member 80, the first end 401 of the power cord 400 is made perpendicular to the second end 402, so that the external outlet end, i.e., the first end 401, is smoothly routed along the surface of the housing 100, avoiding cable damage caused by excessive bending or compression during installation of microwave ovens, especially built-in microwave ovens.

### Embodiment 4

In existing cooking appliance, when food is placed close to the door assembly 300, the front and rear weight of the partition component 21 becomes unbalanced, making it prone to tipping when the partition component 21 and food are pulled out. To address this, the applicant proposes the following technical solution:

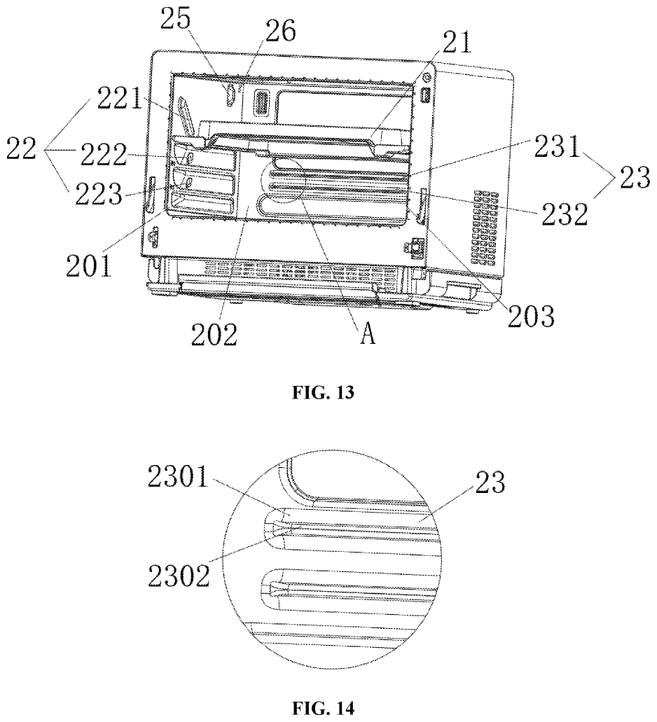

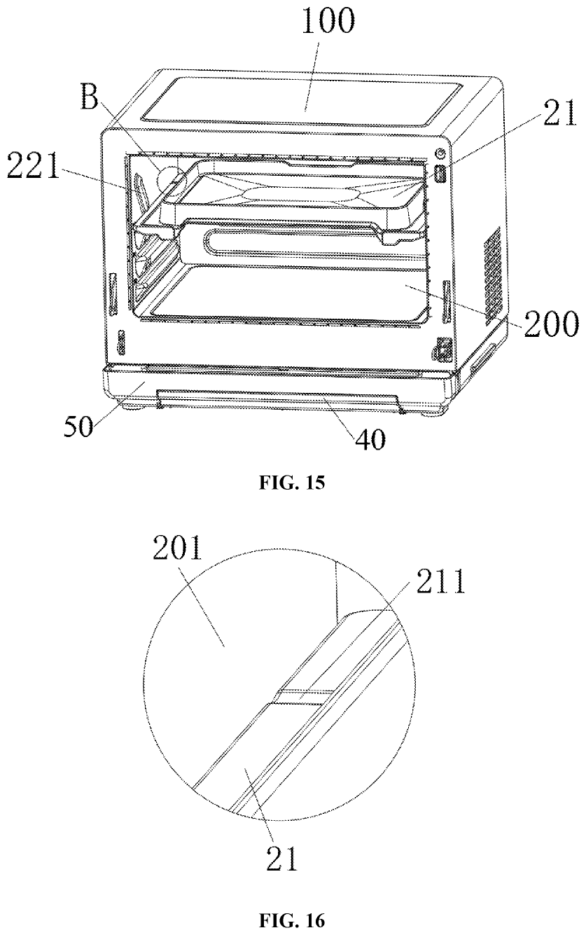

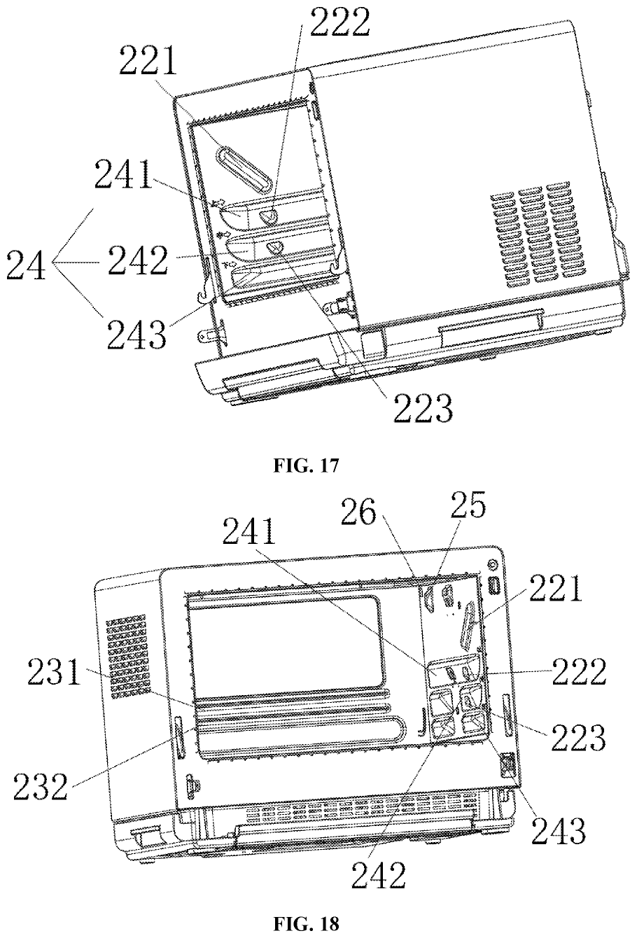

As shown in FIGS. 13-18, a cooking appliance comprises a housing 100, wherein a heating chamber 200 is disposed within the housing 100, the heating chamber 200 is formed with an opening 203, and a support structure 24 is disposed on the side wall 201 of the heating chamber 200 for supporting the partition component 21; the partition component 21 is disposed above the support structure 24, a limiting protrusion structure 22 is disposed on the side wall 201, the limiting protrusion structure 22 is disposed above the partition component 21 and the limiting protrusion structure 22 is disposed on the side close to the opening 203, and the limiting protrusion structure 22 is capable of limiting the partition component 21 when the partition component 21 is pulled out.

The cooking appliance of this embodiment, by providing the limiting protrusion structure 22, is capable of limiting the partition component 21 when it is pulled out, preventing tipping when the partition component 21 is partially pulled out; the combination of the support structure 24 and the limiting protrusion structure 22 ensures the stability and safety of the partition component 21 during the pulling-out process.

As a preferred example of this application, grooves 211 are disposed on the left and right sides of the partition component 21, the grooves 211 are disposed on the side away from the opening 203, and the grooves 211 cooperate with the limiting protrusion structure 22. This arrangement reduces resistance when the partition component 21 is pulled out, making the operation smoother.

As a preferred example, the lower portion of the limiting protrusion structure 22 is configured as an arcuate structure, and the grooves 211 are configured as arcuate grooves. This arrangement further reduces resistance when the partition component 21 is pulled out, making the operation smoother.

As a preferred example, the support structure 24 includes a first support protrusion 241, a second support protrusion 242, and a third support protrusion 243 spaced apart from top to bottom, ensuring stable support for the partition component 21. The limiting protrusion structure 22 includes a first limiting protrusion 221, and the first limiting protrusion 221 is disposed obliquely above the first support protrusion 241.

As a preferred example, the first limiting protrusion 221 is arranged inclined toward the direction close to the opening 203, and the inclination angle of the first limiting protrusion 221 is α, where α satisfies: 10~80°. This can both effectively limit the partition component 21 and reduce resistance when the partition component 21 is withdrawn.

As a preferred example, the limiting protrusion structure 22 further includes a second limiting protrusion 222, and the second limiting protrusion 222 is disposed on the first support protrusion 241, which enhances the structural stability of the second limiting protrusion 222.

As a preferred example, the limiting protrusion structure 22 further includes a third limiting protrusion 223, and the third limiting protrusion 223 is disposed on the second support protrusion 242, which enhances the structural stability of the third limiting protrusion 223.

As a preferred example, a guiding reinforcement structure 23 is disposed on the rear wall 202 of the heating chamber 200. This arrangement improves the structural strength of the rear wall 202 of the heating chamber 200, while the guiding reinforcement structure 23 can provide support for the partition component 21, ensuring the stability and safety of the partition component 21 placement. In addition, it can also guide the withdrawal direction of the partition component 21, making the withdrawal operation of the partition component 21 smoother.

As a preferred example, the guiding reinforcement structure 23 includes a guiding reinforcing rib main body 2301, and the guiding reinforcing rib main body 2301 is arranged extending toward the direction of the opening 203. A guiding reinforcing edge 2302 is disposed on the guiding reinforcing rib main body 2301, and the guiding reinforcing edge 2302 is arranged extending toward the direction of the opening 203.

As a preferred example, the guiding reinforcement structure 23 includes a first guiding reinforcing rib 231 and a second guiding reinforcing rib 232 arranged at intervals from top to bottom.

As a preferred example, a sensor 26 is disposed on the side wall 201 of the heating chamber 200, and the sensor 26 is used to monitor various parameters during the cooking process. A protective protrusion 25 is disposed on the side of the sensor 26 close to the opening 203, and the protective protrusion 25 can protect the sensor 26 from accidental collision or damage. The protective protrusion 25 is arranged extending toward the center direction of the heating chamber 200. The provision of the sensor 26 and the protective protrusion 25 can further enhance the practicality and safety of the cooking appliance.

As a preferred example of the present application, the cooking appliance includes a door assembly 300, wherein the door assembly 300 is located at the front side of the housing 100 for sealing or opening the heating chamber 200, and the door assembly 300 is rotatably connected to the housing 100. Preferably, the door assembly 300 is located directly above the water tank 50.

The cooking appliance includes, but is not limited to, kitchen appliances such as microwave ovens, ovens, steamers, and multi-function integrated appliances. In the present embodiment, the cooking appliance is a microwave oven. The internal volume of the cooking appliance is not specifically limited, and its size can be adjusted according to actual requirements. Preferably, the internal volume of the cooking appliance is 30 L. This volume size can meet most cooking needs while also taking into account factors such as portability of the equipment, energy consumption, and manufacturing costs.

As a preferred example of the present application, the cooking appliance is a dual-magnetron microwave oven, including a first magnetron and a second magnetron that are independently arranged. The dual-magnetron microwave oven can ensure high power output is maintained throughout the heating process through the independent linkage of the two magnetrons; the two magnetrons can respectively control different regions within the microwave oven, thereby achieving a more uniform heating effect, which helps reduce hot spots and cold spots in food and improve cooking quality.

Although the present invention is disclosed as above, the present invention is not limited thereto. Any person skilled in the art may make various changes and modifications without departing from the spirit and scope of the present invention. Therefore, the protection scope of the present invention shall be defined by the scope of the claims.

1. A cooking appliance, comprising a housing, wherein a heating chamber is provided inside the housing, a support structure is provided on a side wall of the heating chamber for supporting a partition component, a limiting protrusion structure is provided on the side wall for limiting when the partition component is pulled out; the housing comprises a base, the base is located at a lower portion of the heating chamber, a pullable storage member is provided below the base, and a gap exists between the storage member and the base.

2. The cooking appliance according to claim 1, wherein the cooking appliance comprises a first protective member and a second protective member, the first protective member and the second protective member are respectively located on both sides of the base and cooperate with each other to form a slide track, and the storage member is slidably assembled to the slide track.

3. The cooking appliance according to claim 2, wherein the first protective member and/or the second protective member is connected to the base through screw connection and/or snap connection, or the first protective member and/or the second protective member is integrally formed with the base.

4. The cooking appliance according to claim 2, wherein the cooking appliance comprises a water tank, snap buckles are respectively provided on both sides of the water tank, snap columns are provided on a side of the first protective member and the second protective member adjacent to the water tank, and the snap buckles are capable of being snap-fitted to the snap columns.

5. The cooking appliance according to claim 4, wherein a second handle portion is provided on a front side of the storage member, a bottom portion of the water tank is partially recessed upward to form a clearance zone for accommodating the second handle portion, and the snap buckles are located on both sides of the clearance zone.

6. The cooking appliance according to claim 2, wherein the first protective member and the second protective member are symmetrically provided on both sides of the base, and the first protective member is provided with a first handle portion.

7. The cooking appliance according to claim 1, wherein the housing is provided with a third protective member for protecting a power cord; the power cord comprises a first end and a second end extending along a first direction and a second direction respectively, both the first end and the second end are located within the third protective member, and the third protective member is detachably connected to the housing.

8. The cooking appliance according to claim 7, wherein the first direction and the second direction are arranged perpendicular to each other, and the third protective member and the housing are assembled through plug-in connection and screw connection.

9. The cooking appliance according to claim 8, wherein the housing comprises a rear panel, a portion of the rear panel protrudes rearward to form a first mounting platform, a portion of the first mounting platform protrudes rearward to form a second mounting platform, and the third protective member is assembled in a limited position to the first mounting platform.

10. The cooking appliance according to claim 9, wherein the third protective member comprises a main body, one end of the main body is provided with a limiter, one side of the main body is provided with a plug-in block, the second end of the power cord is led out from the plug-in block, the first end of the power cord is led out from the limiter, an insertion hole is provided on the first mounting platform, and the plug-in block is assembled in a limited position within the insertion hole.

11. The cooking appliance according to claim 10, wherein an open slot is provided between the main body and the plug-in block, the open slot is located at an end of the main body proximate to the limiter, and the bottom of the open slot abuts against the upper edge of the insertion hole.

12. The cooking appliance according to claim 1, wherein the partition component is disposed above the support structure, and the limiting protrusion structure is disposed above the partition component and the limiting protrusion structure is disposed on a side proximate to the opening.

13. The cooking appliance according to claim 12, wherein grooves are disposed on left and right sides of the partition component, the grooves are disposed on a side distal from the opening, and the grooves cooperate with the limiting protrusion structure.

14. The cooking appliance according to claim 12, wherein the support structure comprises a first support protrusion, the limiting protrusion structure comprises a first limiting protrusion, the first limiting protrusion is obliquely disposed above the first support protrusion, and the first limiting protrusion is obliquely disposed in a direction proximate to the opening with an inclination angle α of 10° to 80°.

15. The cooking appliance according to claim 14, wherein the limiting protrusion structure further comprises a second limiting protrusion, and the second limiting protrusion is disposed on the first support protrusion.

16. The cooking appliance according to claim 1, wherein the housing comprises a rear panel, the rear panel is provided with a detachable handle member, and a handle space is formed between the handle member and the rear panel.

17. The cooking appliance according to claim 16, wherein the cooking appliance comprises an anti-collision member, and the anti-collision member is connected to a protrusion portion of the rear panel in a detachable manner.

18. The cooking appliance according to claim 1, wherein the cooking appliance comprises a first magnetron and a second magnetron disposed on the base.
